(19) United States
(12) Patent Application Publication
(10) Pub. No.: US 2004/0194612 A1
(43) Pub. Date: Oct. 7, 2004

(54) Method, system and program product for automatically categorizing computer audio files

(75) Inventor: Benjamin Michael Parees, Raleigh, NC (US)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/408,377

(22) Filed: Apr. 4, 2003

(51) Int. Cl. G04B 13/00; A63H 5/00; G10H 7/00

(52) U.S. Cl. 84/609

(57) ABSTRACT

Under the present invention, audio characteristics of computer audio files are analyzed (measured). Based on the analysis, baseline ratings are determined. Final ratings are then determined by scaling each baseline rating relative to one another to fit within a fixed range. A setting can then be established for a playing device so that only computer audio files having a final rating that meets the established setting will be played.

### BACKGROUND OF THE INVENTION

1. Field of the Invention

The present invention generally relates to a method, system and program product for automatically categorizing computer audio files. Specifically, based on audio characteristics thereof, the present invention automatically categorizes computer audio files in a collection with respect to one another.

2. Background Art

As computer usage and the Internet become household capabilities, consumers are increasingly able to perform everyday functions from the comfort of their homes. For example, today, a consumer can purchase goods/services, pay bills and advertise a business using a home computer. One area of particular growth fostered by improving computer technology is the dissemination of computer audio files. Specifically, with the growing popularity of audio media stored in a digital format (e.g., MP3) consumers have recently been presented with the ability to accumulate and access large collections of music without the difficulty of finding and loading individual compact disks, records or tapes.

Unfortunately, when faced with a collection of 500, 1,000 or 10,000 audio files, a new challenge arises. In particular, it becomes extremely difficult to listen to a certain type of music the consumer wants at any given time. That is, while selecting an individual song is generally easy, selecting several songs of a particular genre can be tedious. For example, if a consumer wants some gentle “mood” music for the evening, he/she must undertake the painstaking task of individually selecting 20 or 30 songs from a list of potentially thousands. The consumer must then do this again if they wish to change the genre, for example, to Top 40 for a party.

Currently, the only option available to consumers is to manually review their audio collection and group the songs by genre. Since a collection can have a countless quantity of songs, such an undertaking can be extremely time consuming and inefficient. Moreover, each time a new song is acquired, it must be manually fit within the collection.

In view of the foregoing, there exists a need for a method, system and program product for automatically categorizing computer audio files. Specifically, a need exists for a system that can parse and analyze audio characteristics of a collection of computer audio files. Still yet, a need exists for the computer audio files to be automatically categorized based on the analysis.

### SUMMARY OF THE INVENTION

In general, the present invention provides a method, system and program product for automatically categorizing computer audio files. Specifically, under the present invention, audio characteristics (e.g., frequency, average volume, etc.) of a plurality of computer audio files will be individually parsed and analyzed. Based on the analysis, a baseline rating will be determined for each audio file. Once the baseline ratings have been determined, they will be scaled relative to one another to fit within a fixed range (e.g., 0 to 100) to yield a final rating. The final ratings represent general “harshness” ratings of the audio files. For example, easy listening songs can be on one end of the fixed range (e.g., 0-10), while heavy metal songs can be on the opposite end (e.g., 90-100). In any event, the final ratings are then stored in a data structure such as a list, table or the like that is accessible to a playing device (e.g., an MP3 player). Typically, the playing device will have the capability to establish a desired setting (e.g., 30-40) within the fixed range (e.g., 0-100). Once this setting is established, only songs having a final rating that meets the setting will be played. Thus, the present invention eliminates the necessity of manually picking and/or categorizing individual songs.

According to a first aspect of the present invention, a method for automatically categorizing computer audio files is provided. The method comprises: (1) providing a plurality of computer audio files; (2) analyzing audio features of each of the plurality of computer audio files; (3) determining a baseline rating for each of the plurality of computer audio files based on the analysis; and (4) determining a final rating for each of the plurality of computer audio files by scaling the baseline ratings to fit within a fixed range.

According to a second aspect of the present invention, a system for automatically categorizing computer audio files is provided. The system comprises: (1) an analysis system for analyzing audio characteristics of a plurality of computer audio files, and for determining a baseline rating for each of the plurality of computer audio files based on the analysis; and (2) a scaling system for determining a final rating for each of the plurality of computer audio files by scaling each baseline rating to fit within a fixed range.

According to a third aspect of the present invention, a program product stored on a recordable medium for automatically categorizing computer audio files is provided. When executed, the program product comprises: (1) program code for analyzing audio characteristics of a plurality of computer audio files, and for determining a baseline rating for each of the plurality of computer audio files based on the analysis; and (2) program code for determining a final rating for each of the plurality of computer audio files by scaling each baseline rating to fit within a fixed range.

Therefore, the present invention provides a method, system and program product for automatically categorizing computer audio files.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for automatically categorizing computer audio files according to the present invention.

FIG. 2 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system and program product for automatically categorizing computer audio files. Specifically, under the present invention, audio characteristics (e.g., frequency, average volume, etc.) of a plurality of computer audio files will be individually parsed and analyzed. Based on the analysis, a baseline rating will be determined for each audio file. Once the baseline ratings have been determined, they will be scaled relative to one another to fit within a fixed range (e.g., 0 to 100) to yield a final rating. The final ratings represent a general “harshness” ratings of the audio files. For example, easy listening songs can be on one end of the fixed range (e.g., 0-10), while heavy metal songs can be on the opposite end (e.g., 90-100). In any event, the final ratings are then stored in a data structure such as a table or the like that is accessible to a playing device (e.g., an MP3 player). Typically, the playing device will have the capability to establish a desired setting (e.g., 30-40) within the fixed range (e.g., 0-100). Once this setting is established, only songs having a final rating that meets the setting will be played. Thus, the present invention eliminates the necessity of manually picking and/or categorizing individual songs.

It should be understood in advance, that as used herein, the term computer audio file is intended to mean a file (e.g., MP3, WAV, etc.) readable/executable by a computerized device that includes audio content. Examples of content that could be included in an audio file include, songs, dialogue (e.g., lectures), etc.

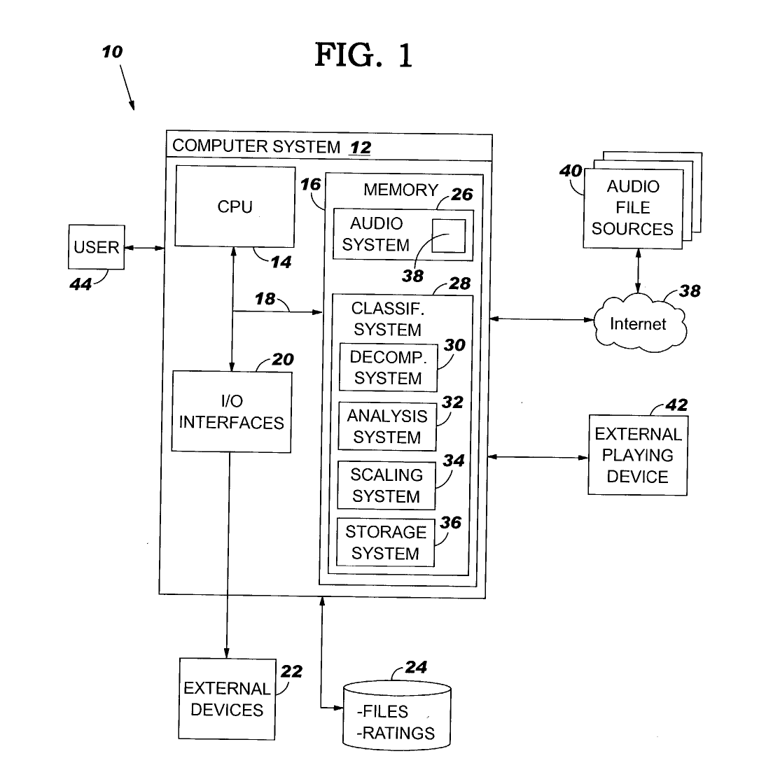

Referring now to FIG. 1 a system 10 for automatically categorizing computer audio files is shown under the present invention. As depicted, system 10 includes computer system 12, which can be any type of computerized system capable of executing/playing computer audio files. For example, computer system 12 could be a workstation, laptop, client, server, hand-held device, etc. As depicted, computer system 12 generally includes central processing unit (CPU) 14, memory 16, bus 18, input/output (I/O) interfaces 20, external devices/resources 22 and storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LED screen, hand-held device, keyboard, mouse, voice recognition system, speech output system, printer, monitor/display, facsimile, pager, etc. Bus 18 provides a communication link between each of the components in computer system 12 and likewise may comprise any known type of transmission link, including electrical, optical, wireless, etc. In addition, although not shown, additional components, such as cache memory, communication systems, system software, etc., may be incorporated into computer system 12.

Storage unit 24 can be any system (e.g., a database) capable of providing storage for computer audio files and/or ratings under the present invention. As will be further described below, the ratings will be used to automatically categorize computer audio files. Storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). Storage unit 24 may also be configured in such a way that one of ordinary skill in the art may interpret it to include one or more storage devices.

Under the present invention, it is assumed that computer system 12 obtains/receives computer audio files in a legal fashion. For example, computer system 12 could receive computer audio files directly from user 44 (e.g., from user's personal CD collection). Alternatively, computer system 12 could obtain the computer audio files from audio file sources 40 over a network such as the Internet 38. In the case of the latter, it is assumed that audio file sources 40 provide the computer audio files pursuant to a legal subscription-based service or the like. In any event, it should be understood that the manner in which computer system 12 legally obtains the computer audio files is not intended to be a limiting part of the present invention.

As shown, user 44 and optional external playing device 42 (e.g., a hand-held MP3 player) communicate with computer system 12 directly, while audio file sources 40 communicate over Internet 38. However, it should be understood that this need not be the case. Rather, communication with computer system 12 can occur in any known manner. That is, communication with computer system 12 could occur a direct hardwired connection (e.g., serial port), or via an addressable connection in a client-server (or server-server) environment that may utilize any combination of wireline and/or wireless transmission methods. In the case of the latter, the server and client may be connected via Internet 38, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via Internet 38, connectivity could be provided by conventional TCP/IP sockets-based protocol. In this instance, the client would utilize an Internet service provider to establish connectivity to the server.

Stored in memory 16 of computer system 12 is audio system 26 and classification system 28. Audio system 26 is intended to incorporate any program(s) now known or later developed (e.g., Music Jukebox) that is capable of converting audio content into a computer audio file (e.g., music on a compact disk into MP3 format), and/or playing computer audio files. To this extent, computer system 12 could function as a playing device and/or as a “staging ground” for converting computer audio files for playing on external playing device 42 (e.g., a hand-held MP3 player). As will be further described below, under the present invention, audio system 26 is adapted to include setting system 38 that will be used to play back music having a certain “harshness” rating.

Under the present invention, classification system 28 automatically classifies computer audio files based upon a “harshness” rating of the audio content therein. For example, if a user possesses 500 computer audio files that each contains a single song, classification system 28 will analyze each song. Based on the analysis, a rating along a fixed range will be assigned to each song. The ratings of the songs are relative to one another and generally indicate how “harsh” the songs are. Thus, in a collection having classical music as well as heavy metal, the heavy metal songs would likely have a rating on one end of the fixed range, while classical music would likely have a rating on the other end of the fixed range.

As shown, classification system 28 includes decompression system 30, analysis system 32, scaling system 34 and storage system 36. Under the present invention, if the computer audio files are provided in MP3 or a similar format, decompression system 30 will first decompress the files. The decompression of an MP3 file will reveal a resulting WAV computer audio file. If, however, a computer audio file is already in a decompressed format, decompression system 30 will not need to perform additional decompression. In any event, once a computer audio file is decompressed, analysis system 32 will analyze the audio characteristics thereof. In a typical embodiment, analysis system 32 will measure/quantify audio characteristics that indicate how harsh the audio content is, or would indicate the type of audio content. Examples of such relevant audio characteristics include frequency of the audio content (e.g., in Hz), variation in frequency (e.g., how many times the frequency changes during the song), average volume (e.g., in decibels), etc. Audio characteristics such as these indicate both the speed and the loudness of the audio content. It should be understood that the teachings of the present invention are not intended to be limited to these illustrative audio characteristics. Rather, any audio characteristics that would indicate a harshness level of the audio content could be measured under the present invention.

In any event, audio characteristics such as frequency and variation in frequency are typically measured by analyzing the waveforms associated with the audio content. To this extent, it can be generally assumed that audio content with a higher frequency (i.e., faster music) is harsher than audio content with a lower frequency (i.e., slower music). In addition, audio content that has a high number of variations in frequency (i.e., music that changes pace a number of times) is generally harsher than audio content with a steady pace. Measurement of average volume can be based on the average volume at which the audio content was recorded. To this extent, the average volume is typically derived from the way amplitude is represented in the computer audio file (e.g., the WAV file). In general, the average volume values can range from −32768 to 32767, with absolute values being used under the present invention.

Based upon the analysis, analysis system 32 will determine a baseline rating for each computer audio file. In one embodiment, determining a baseline rating generally involves taking the average of the measured audio characteristics. For example, if a frequency of a song was determined to be 3000 Hz, the frequency was varied 4000 times, and the average volume was 4000, the baseline rating could be calculated as follows:

$$\frac{( 3000 + 4000 + 4000 )}{3} = 3666$$

Under the present invention, the baseline ratings can generally range from 2000 to 9000, with 2000 representing the least harsh and 9000 representing the harshest audio content. It should be understood that the algorithm shown above for calculating a baseline rating is intended to be illustrative only, and other algorithms could be implemented. For example, a weighting factor could be applied to one or more of the audio characteristics before computing the baseline value. This is such that if average volume was regarded as twice as important as the other factors in determining harshness, the average volume value of 4000 could be multiplied by 2.0 before computing the average of the three values to determine the baseline value (which would then be 5000). Similarly, if the average volume was regarded as half as important as the other audio characteristics, the value of 4000 could be multiplied by 0.5 (which would yield a baseline value of 3000).

In addition to a baseline rating, analysis system 32 can also determine a “volume” rating for each computer audio file. The volume ratings are generally based on the average recorded volume of each piece of audio content and, as will be further described below, will be used to dynamically adjust a volume of a playing device. In one embodiment, the volume ratings are determined relative to one another on a fixed scale, (e.g., 0-10). Alternatively, the volume ratings could merely be the volume in decibels at which each computer audio file was recorded.

In any event, once a baseline rating and an optional volume rating have been determined for each computer audio file, scaling system 34 will determine a final rating for each computer audio file by scaling the baseline ratings (relative to one another) to fit within a fixed range. In a typical embodiment, the fixed range is 0-100. The baseline scores are scaled/normalized down to fit within the fixed range so that computer audio files having the least harsh audio content is on one end (e.g., 0), while computer audio files having the most harsh audio content is on the opposite end (e.g., 100). These final ratings thus represent the categorization of the computer audio files. In addition, because the computer audio files are classified relative to one another, the same song could have two different final ratings in two different collections. For example, a heavy metal song might have a final rating of 75 in user “A's” collection, while having a final rating of 95 in user “B's” collection. This allows the classification to be highly “personalized” for the individual collection or user.

Once the final ratings for the computer audio files have been determined, storage system 36 will arrange the final ratings and any volume ratings into a data structure such as a list or table, which can be stored in storage unit 24. Typically, the data structure correlates each computer audio file with its final rating and its volume rating. Once the data structure is compiled, it can be used to play audio content having a certain harshness. For example, assume user 44 is having a party and wishes to play music of the Top 40 genre. User 44 will establish an appropriate harshness setting within the fixed range (e.g., 40-60) on the device that will be playing the music. For example, if the music will be played on computer system 12, user 44 will interface with setting system 38 of audio system 26, and manually input the setting “40-60.” Alternatively, if the music is to be played by external device, user 44 will establish the setting 40-60 on external playing device 42. To this extent, although not shown, external playing device 42 should be understood to include an audio system 26 similar to computer system 12. Moreover, external playing device 42 will require access to the computer audio files and the data structure. In any event, once the setting is established, audio system 26 will access the data structure (e.g., in storage device 38), and play only the computer audio files that have a final rating that meets the established setting. In this example, audio system 38 will only play the songs that have a final rating from “40-60.” In addition, any volume ratings were that were determined will be used by audio system 38 to dynamically adjust a volume of the playing device (e.g., computer system 12 or external playing device 42) so that a constant volume level of the audio content as outputted is maintained. As known, audio content such as songs are often recorded at different volume levels. For example, song “A” could have been recorded at 40 dB, while song “B” was recorded at 60 dB. The use of volume ratings prevent constant flux in play back volume. For example, if the party host in this illustrative example initially sets the volume knob on the playing device to output music at 50 dB, audio system 26 will increase the initial volume of the playing device so that song “A” is outputted at 50 dB. Conversely, audio system will dynamically adjust the output volume downward when song “B” is to be played. This prevents the party go-ers from straining to hear song “A,” while having to cover their ears for song “B.” Moreover, the party host will not have to constantly adjust the volume knob.

It should be understood that the setting of “40-60” as cited herein is intended to be illustrative only. The setting as established by user 44 could be a single number (e.g., 45), a range (e.g., 40-60), or a limit (e.g., up to 50). Moreover, it should be understood that because the final ratings are determined relative to one another, and pertain to a particular collection of computer audio files, final settings could correspond to completely different harshness levels in different song collections.

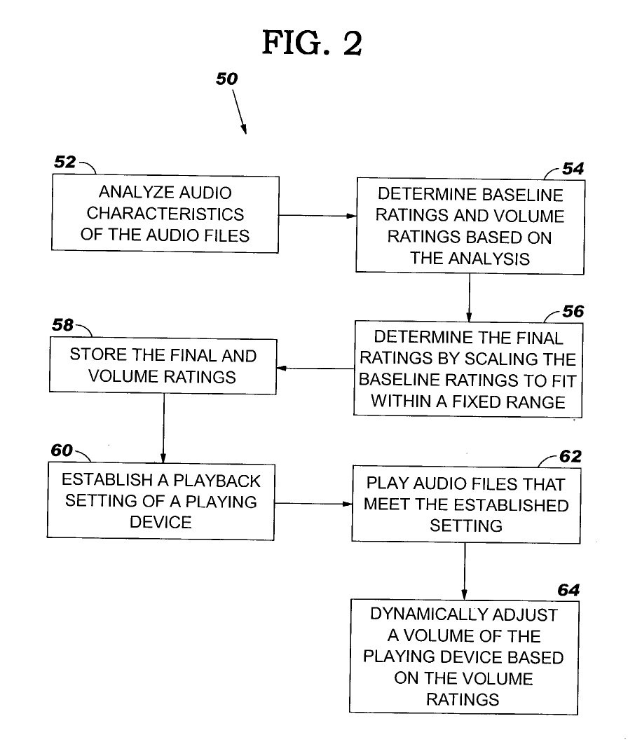

Referring now to FIG. 2, an illustrative method flow diagram 50 is shown. As depicted, first step 52 is to analyze/measure the audio characteristics of the computer audio files. As indicated above, this may or may not include initial file decompression. In any event, based on the analysis, baseline ratings and optional volume ratings are determined in step 54. In step 56, final ratings are determined by scaling the baseline ratings to fit within a fixed range. Once determined, the final ratings are stored in a data structure in step 58. In step 60, a setting is established for a playback device. The setting is used to play the computer audio files having a final rating that meets the established setting in step 62. In step 64, the output volume of the playing device can be dynamically adjusted based on the volume ratings.

It should be understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, although audio system 26 and classification system 28 are shown as separate systems in FIG. 1, they could exist as a single system.

I claim:

1. A method for automatically categorizing computer audio files, comprising providing a plurality of computer audio files;
analyzing audio features of each of the plurality of computer audio files;
determining a baseline rating for each of the plurality of computer audio files based on the analysis; and
determining a final rating for each of the plurality of computer audio files by scaling the baseline ratings to fit within a fixed range.

2. The method of claim 1, wherein each of the plurality of computer audio files is automatically categorized based on its corresponding final rating.

3. The method of claim 1, wherein the final ratings represent harshness ratings of the plurality of audio files.

4. The method of claim 1, wherein the audio features analyzed are selected from the group consisting of audio frequency, variation in audio frequency and average volume.

5. The method of claim 1, wherein the providing step comprises:
providing a plurality of MP3 files; and
decompressing the plurality of MP3 files to reveal a plurality of WAV files.

6. The method of claim 1, wherein the fixed range is from zero to one hundred.

7. The method of claim 1, further comprising arranging the final ratings into a data structure.

8. The method of claim 7, further comprising:
making the data structure accessible to a playing device; and
establishing a desired setting for the playing device that is within the fixed range, wherein the playing device will only play computer audio files that meet the desired setting.

9. The method of claim 8, further comprising:
determining a volume rating for each of the plurality of computer audio files based on the analysis; and
arranging the volume ratings in the data structure.

10. The method of claim 9, comprising automatically adjusting a volume of the playing device based on the volume ratings arranged in the data structure.

11. A system for automatically categorizing computer audio files, comprising:
an analysis system for analyzing audio characteristics of a plurality of computer audio files, and for determining a baseline rating for each of the plurality of computer audio files based on the analysis; and
a scaling system for determining a final rating for each of the plurality of computer audio files by scaling each baseline rating to fit within a fixed range.

12. The system of claim 11, wherein the fixed range is from zero to one hundred.

13. The system of claim 11, further comprising a decompression system for receiving an MP3 file and decompressing the MP3 file to reveal a WAV file.

14. The system of claim 11, wherein the audio features analyzed are selected from the group consisting of audio frequency, variation in audio frequency and average volume.

15. The system of claim 11, wherein the final ratings represent harshness ratings of the plurality of audio files.

16. The system of claim 11, wherein each of the plurality of computer audio files is automatically categorized based on its corresponding final rating.

17. The system of claim 11, further comprising a storage system for storing the final ratings in a data structure.

18. The system of claim 17, wherein the analysis system further determines a volume rating for each of the plurality of computer audio files, and wherein the storage system further arranges the volume ratings in the data structure.

19. The system of claim 18, wherein the data structure is accessible to a playing device, wherein a desired setting that is within the fixed range can be established for the playing device, and wherein the playing device will only play computer audio files that meet the desired setting.

20. The system of claim 19, wherein a volume of the playing device is automatically adjusted based on the volume ratings arranged in the data structure.

21. A program product stored on a recordable medium for automatically categorizing computer audio files, which when executed comprises:
program code for analyzing audio characteristics of a plurality of computer audio files, and for determining a baseline rating for each of the plurality of computer audio files based on the analysis; and
program code for determining a final rating for each of the plurality of computer audio files by scaling each baseline rating to fit within a fixed range.

22. The program product of claim 21, wherein the fixed range is from zero to one hundred.

23. The program product of claim 21, further comprising program code for receiving an MP3 file and decompressing the MP3 file to reveal a WAV file.

24. The program product of claim 21, wherein the audio features analyzed are selected from the group consisting of audio frequency, variation in audio frequency and average volume.

25. The program product of claim 21, wherein the final ratings represent harshness ratings of the plurality of audio files.

26. The program product of claim 21, wherein each of the plurality of computer audio files is automatically categorized based on its corresponding final rating.

27. The program product of claim 21, further comprising program code for storing the final ratings in a data structure.

28. The program product of claim 27, wherein the program code for analyzing further determines a volume rating for each of the plurality of computer audio files, and wherein the storage system further arranges the volume ratings in the data structure.

29. The program product of claim 28, wherein the data structure is accessible to a playing device, wherein a desired setting that is within the fixed range can be established for the playing device, and wherein the playing device will only play computer audio files that meet the desired setting.

30. The program product of claim 29, wherein a volume of the playing device is automatically adjusted based on the volume ratings arranged in the data structure.
